(19) United States
(12) Patent Application Publication
(10) Pub. No.: US 2024/0393012 A1
(43) Pub. Date: Nov. 28, 2024

(54) HEATING WATER

(71) Applicant: Mixergy Limited, Oxfordshire (GB)

(72) Inventors: Peter ARMSTRONG, Oxfordshire (GB); Christopher RANDALL, Oxfordshire (GB)

(73) Assignee: Mixergy Limited, Oxfordshire (GB)

(21) Appl. No.: 18/694,474

(22) PCT Filed: Sep. 22, 2022
(86) PCT No.: PCT/GB2022/052398

§ 371 Date: Mar. 22, 2024

(30) Foreign Application Priority Data
Sep. 22, 2021 (GB) 2113537.1
Feb. 10, 2022 (GB) 2201706.5

(51) Int. Cl. F24H 4/04; F24H 15/238; F24H 15/32; F24H 15/34

(52) U.S. Cl. CPC F24H 4/04; F24H 15/238; F24H 15/32; F24H 15/34

(57) ABSTRACT

Systems, kits of parts and methods for heating water are provided. A tank is provided for holding water and a heat pump provides heat to water of the tank via a heat exchanger. A variable speed pump pumps water from the tank to the heat exchanger and back to the tank and a three port valve is arranged to provide a flow path from the heat exchanger either to the top of the tank or to the bottom of the tank depending on a flow rate. A controller controls the variable speed pump depending on a hot water demand.

The present invention relates to a system for heating water, in particular but not exclusively in connection with a heat pump as heat source, with a view to improving the Coefficient of Performance. Such a system may lend itself to use in domestic or commercial water heating systems where it is necessary or desirable to have a stored quantity of heated water for immediate use.

Heat sources such as ground source heat pumps or air source heat pumps or solar heating systems can provide environmentally friendly heat sources for heating water, but may provide relatively low temperature heat, compared for example to heat sources such as gas boilers or mains powered electrical heating elements. Low temperature heat sources can take a considerable length of time—often several hours—to heat a typical hot water tank to an appropriate temperature. On the other hand it can be desirable to heat only a portion of water for immediate use quickly, when a user has decided that they need it.

There is therefore a need for a system for heating water in connection with a low temperature heat sources that can quickly and efficiently provide hot water to a user on demand.

According to an aspect there is provided a system for heating water including: a tank for holding water; a heat pump to provide heat to water of the tank; a heat exchanger arranged to transfer heat from the heat pump to water of the tank; a variable speed pump for pumping water from the tank to the heat exchanger and back to the tank; a three port valve arranged to provide a flow path from the heat exchanger either to the top of the tank or the bottom of the tank depending on a flow rate; and a controller adapted to control the variable speed pump depending on a hot water demand.

It has been recognised that by providing a three port valve that switches flow paths depending on a flow rate robust control of the heating and switching between different use requirements can be enabled. It has been recognised that by diverting heat into either top or bottom of the tank one or the other different use scenarios can be accommodated, and in particular heating of either only a portion of hot water (i.e. a portion of the tank) for immediate use can be enabled or slower, gradual but more energy efficient heating of the whole tank can be provided. As the quantity of heat provided can vary across heat pumps (with different heat pumps but also with different conditions such as season), ensuring efficient use of the available heat and also accommodating different demands (immediate demand, planned demand) can be enabled.

For particularly simple and robust control of heating and switching between different use requirements, the three port valve may be a passive three port valve. Alternatively, the three port valve may be actively controlled, for example, by the controller.

For effective heating of water for different use requirements, the three port valve may be arranged to provide a flow path from the heat exchanger to the top of the tank at a low flow rate, and to provide a flow path from the heat exchanger to the bottom of the tank at a high flow rate. The low flow rate may be 5 l/min or less. The high flow rate may be 5 l/min or more, 10 l/min or more; 15 l/min or more.

For effective control the controller may be adapted to control the variable speed pump at a low flow rate in response to an immediate hot water demand or otherwise a high flow rate. The low flow rate may be 5 l/min or less. The high flow rate may be 5 l/min or more, 10 l/min or more; 15 l/min or more.

The three port valve may comprise a housing, a moveable shuttle, and an elastically deformable element arranged to urge the shuttle in the housing against flow into the three port valve.

For effective heating of water for immediate use the system may further comprising a diffuser in the top of the tank arranged to receive heated water from the heat exchanger.

For effective heating of water for immediate use the one of the flow paths from the heat exchanger may be to a top ⅓ (by height) of the tank. The one of the flow paths from the heat exchanger may be to a bottom ⅓ (by height) of the tank.

According to another aspect there is provided a method of heating water in a tank with a heat pump, the method including: controlling a variable speed pump depending on a hot water demand; pumping, by the variable speed pump, water in a hot water circuit from a tank to a heat exchanger for transferring heat from the heat pump to the water, and back to the tank; and forming, by a three port valve, a flow path from the heat exchanger either to the top of the tank or to the bottom of the tank depending on a flow rate. Optionally, the three port valve is a passive three port valve.

According to another aspect there is provided a kit of parts for a system for heating water in a tank with a heat pump, the kit of parts including: a heat exchanger for attachment (i) to a heating fluid circuit from a heat pump to provide heat; and (ii) to a hot water circuit from a tank to receive heat; a variable speed pump for pumping water in the hot water circuit from the tank to the heat exchanger and back to the tank; a three port valve for forming a flow path from the heat exchanger either to the top of the tank or to the bottom of the tank depending on a flow rate; and a controller adapted to control the variable speed pump depending on a hot water demand.

The kit of parts can be retrofit to an existing hot water tank and heat pump for improvement of the versatility and performance of the heating system.

For particularly simple and robust control of heating and switching between different use requirements, the three port valve may be a passive three port valve.

The three port valve may comprise a housing, a moveable shuttle, and an elastically deformable element arranged to urge the shuttle in the housing against flow into the three port valve.

For effective heating of water for different use requirements the three port valve may be arranged to provide a flow path to a first outlet port when a flow rate is 5 l/min or more; 10 l/min or more; or 15 l/min or more. The three port valve may be arranged to provide a flow path to a second outlet port when a flow rate is 5 l/min or less.

For effective control the controller may be adapted to control the variable speed pump at a low flow rate in response to an immediate hot water demand or otherwise a high flow rate. The low flow rate may be 5 l/min or less. The high flow rate may be 5 l/min or more; 10 l/min or more; or 15 l/min or more.

According to an aspect there is provided a system for heating water including: a tank for holding water; a heat pump to provide heat to water of the tank; a first heat exchanger arranged to transfer heat from the heat pump to water of the tank for gradual heating to a use temperature; a second heat exchanger arranged to transfer heat from the heat pump to water of the tank for immediate heating to a use temperature; a three port valve arranged to provide a flow path from the heat pump either toward the first heat exchanger or toward the second heat exchanger; and a controller adapted to control the three port valve depending on a hot water demand.

It has been recognised that by providing a first and second heat exchanger and diverting heat into either one or the other different use scenarios can be accommodated, and in particular either only a portion of hot water (i.e. a portion of the tank) for immediate use or slower, gradual but more energy efficient heating of the whole tank. As the quantity of heat provided can vary across heat pumps (with different heat pumps but also with different conditions such as season), ensuring efficient use of the available heat and also accommodating different demands (immediate demand, planned demand) can be enabled.

For ease of retrofit the first heat exchanger may be outside the tank, with a pump arranged to pump water from the tank to the first heat exchanger and back to the tank.

For efficient use of the available heat the pump may be a variable speed pump adapted to pump the water at a high flow rate, preferably at least 5 l/min, more preferably at least 10 l/min, yet more preferably at least 15 l/min.

For effective heating of water throughout the tank the system may further comprise a conduit arranged to return water from the first heat exchanger to the bottom of the tank.

For effective heating of water for immediate use the second heat exchanger may be inside the tank.

For effective heating of water for immediate use the second heat exchanger may at the top of the tank, at a top portion of the tank, or near the top of the tank, preferably in a top ⅓ (by height) of the tank.

For ease of control the three port valve is preferably electronically controllable.

For versatility the system may comprise a diffuser in the top of the tank (or in a top portion of the tank, or near the top of the tank) and a pump arranged to pump water from the bottom of the tank (or from a bottom portion of the tank, or from near the bottom of the tank) to the diffuser. This can permit heating of a larger portion of water in the tank than otherwise with the second heat exchanger.

According to another aspect there is provided a method of heating water in a tank with a heat pump, the method including: forming, by way of a three port valve, a heating fluid circuit to connect the heat pump either to a first heat exchanger or to a second heat exchanger; controlling the three port valve depending on a hot water demand; where the first heat exchanger is arranged to transfer heat from the heat pump to water of the tank for gradual heating to a use temperature and the second heat exchanger is arranged to transfer heat from the heat pump to water of the tank for immediate heating to a use temperature; and preferably pumping, by way of a variable speed pump, water in a hot water circuit from the tank to the first heat exchanger and back to the tank.

According to another aspect there is provided a kit of parts for a system for heating water in a tank with a heat pump, the kit of parts including: a first heat exchanger for attachment (i) to a heating fluid circuit from a heat pump to provide heat; and (ii) to a hot water circuit from a tank to receive heat; a variable speed pump for pumping water in the hot water circuit from the tank to the first heat exchanger and back to the tank; a conduit for attachment of a second heat exchanger in the tank to the heating fluid circuit to provide heat to the tank; a three port valve for forming the heating fluid circuit to connect the heat pump either to the first heat exchanger or to the second heat exchanger; and a controller adapted to control the three port valve depending on a hot water demand.

The kit of parts can be retrofit to an existing hot water tank and heat pump without requiring extensive adaptation of the controller to the specific heat pump.

For ease of control the three port valve is preferably electronically controllable.

According to another aspect there is provided a system for heating water including: a tank for holding water; a heat pump to provide heat to water of the tank; a heat exchanger arranged to transfer heat from the heat pump to water of the tank; a variable speed pump for pumping water from the tank to the heat exchanger and back to the tank; a passive three port valve arranged to provide a flow path from the heat exchanger either to the top of the tank or to the bottom of the tank depending on a flow rate; and a controller adapted to control the variable speed pump depending on a hot water demand.

It has been recognised that by providing a passive three port valve that switches flow paths depending on a flow rate can enable particularly robust control of the heating and switching between different use requirements.

For effective heating of water for different use requirements, the passive three port valve may be arranged to provide a flow path from the heat exchanger to the top of the tank at a low flow rate, and to provide a flow path from the heat exchanger to the bottom of the tank at a high flow rate. The low flow rate may be 5 l/min or less. The high flow rate may be 5 l/min or more, 10 l/min or more; 15 l/min or more.

For effective control the controller may be adapted to control the variable speed pump at a low flow rate in response to an immediate hot water demand or otherwise a high flow rate. The low flow rate may be 5 l/min or less. The high flow rate may be 5 l/min or more, 10 l/min or more; 15 l/min or more.

The passive three port valve may comprise a housing, a moveable shuttle, and an elastically deformable element arranged to urge the shuttle in the housing against flow into the passive three port valve.

For effective heating of water for immediate use the system may further comprising a diffuser in the top of the tank arranged to receive heated water from the heat exchanger.

For effective heating of water for immediate use the one of the flow paths from the heat exchanger may be to a top ⅓ (by height) of the tank. The one of the flow paths from the heat exchanger may be to a bottom ⅓ (by height) of the tank.

According to another aspect there is provided a method of heating water in a tank with a heat pump, the method including: controlling a variable speed pump depending on a hot water demand; pumping, by the variable speed pump, water in a hot water circuit from a tank to a heat exchanger for transferring heat from the heat pump to the water, and back to the tank; and forming, by a passive three port valve, a flow path from the heat exchanger either to the top of the tank or to the bottom of the tank depending on a flow rate.

According to another aspect there is provided a kit of parts for a system for heating water in a tank with a heat pump, the kit of parts including: a heat exchanger for attachment (i) to a heating fluid circuit from a heat pump to provide heat; and (ii) to a hot water circuit from a tank to receive heat; a variable speed pump for pumping water in the hot water circuit from the tank to the heat exchanger and back to the tank; a passive three port valve for forming a flow path from the heat exchanger either to the top of the tank or to the bottom of the tank depending on a flow rate; and a controller adapted to control the variable speed pump depending on a hot water demand.

The kit of parts can be retrofit to an existing hot water tank and heat pump for improvement of the versatility and performance of the heating system.

The passive three port valve may comprise a housing, a moveable shuttle, and an elastically deformable element arranged to urge the shuttle in the housing against flow into the passive three port valve.

For effective heating of water for different use requirements the passive three port valve may be arranged to provide a flow path to a first outlet port when a flow rate is 5 l/min or more; 10 l/min or more; or 15 l/min or more. The passive three port valve may be arranged to provide a flow path to a second outlet port when a flow rate is 5 l/min or less.

For effective control the controller may be adapted to control the variable speed pump at a low flow rate in response to an immediate hot water demand or otherwise a high flow rate. The low flow rate may be 5 l/min or less. The high flow rate may be 5 l/min or more; 10 l/min or more; or 15 l/min or more.

According to an aspect described herein, a passive three port valve for system for heating water is provided, the passive three port valve being configured to provide a flow path to either a first output port or a second output port depending on a flow rate of water through the passive three port valve.

According to an aspect described herein, a passive three port valve is provided comprising a housing, a moveable shuttle, and an elastically deformable element arranged to urge the shuttle in the housing against flow into the passive three port valve.

For effective heating of water for different use requirements the three port valve according to any aspect herein may be arranged to provide a flow path to the first outlet port when a flow rate is 5 l/min or more; 10 l/min or more; or 15 l/min or more. The three port valve may be arranged to provide a flow path to the second outlet port when a flow rate is 5 l/min or less.

According to another aspect there is provided a system for heating water including: a tank for holding water; a heat pump to provide heat to water of the tank; a heat exchanger arranged to transfer heat from the heat pump to water of the tank; a first pump arranged to pump water from the tank to the heat exchanger and back to an upper region of the tank; a second pump arranged to pump water from the tank to the heat exchanger and back to a lower region of the tank; and a controller adapted to control the first pump and the second pump depending on a hot water demand. It has been recognised that by controlling the first pump and the second pump flow paths can be switched depending on different use requirements.

Preferably a three-way junction is provided between the heat exchanger, the first pump and the second pump. The three-way junction can enable and/or is arranged to provide a first flow path to the first pump and onward to an upper region of the tank and a second flow path to the second pump and onward to a lower region of the tank. To prevent unintended flows the first flow path and/or the second flow path may include a check valve.

For effective heating of water for different use requirements the controller may be adapted to switch on the first pump at a low flow rate or to switch on the second pump at a high flow rate. The low flow rate may be 5 l/min or less. The high flow rate may be 5 l/min or more, 10 l/min or more; 15 l/min or more.

For effective control the controller may be adapted to switch on the first pump in response to an immediate hot water demand. The controller may be adapted to switch on the second pump in the absence of an immediate hot water demand.

For effective heating of water for immediate use the system may further comprising a diffuser in the top of the tank arranged to receive heated water from the heat exchanger.

For effective heating of water for immediate use the first pump may be arranged to pump water to a top ⅓ (by height) of the tank. The second pump may be arranged to pump water to a bottom ⅓ (by height) of the tank.

Any apparatus feature as described herein may also be provided as a method feature, and vice versa.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

These and other aspects of the present invention will become apparent from the following exemplary embodiments that are described with reference to the following figures in which:

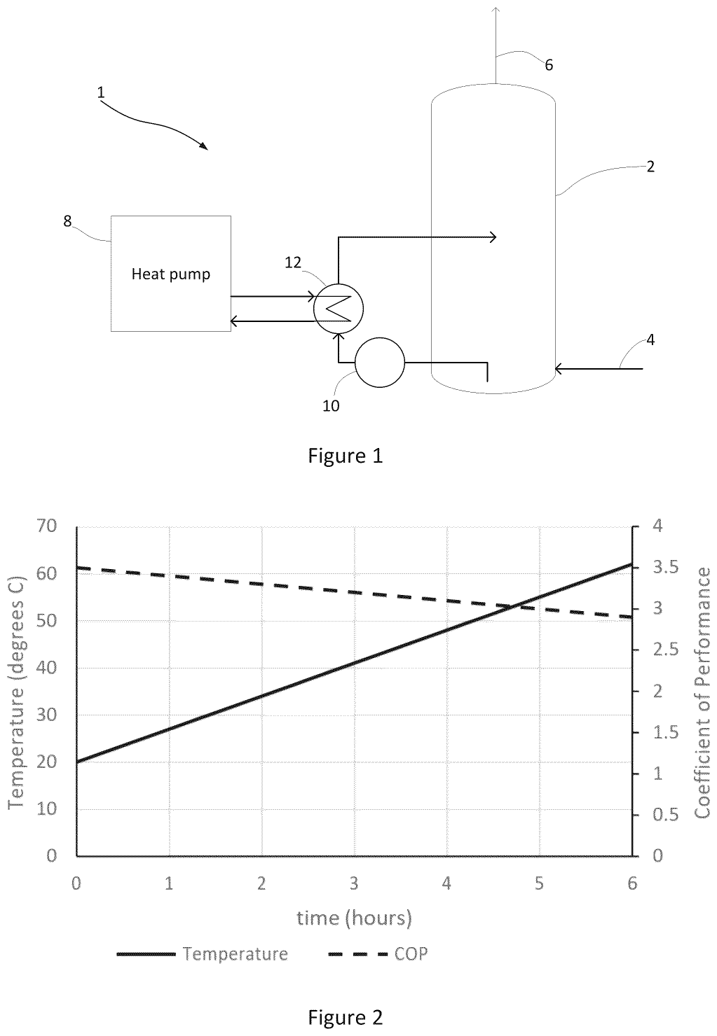

FIG. 1 is a schematic of a hot water tank arrangement;

FIG. 2 is a graph of temperature and COP as a tank is heated according to a first example;

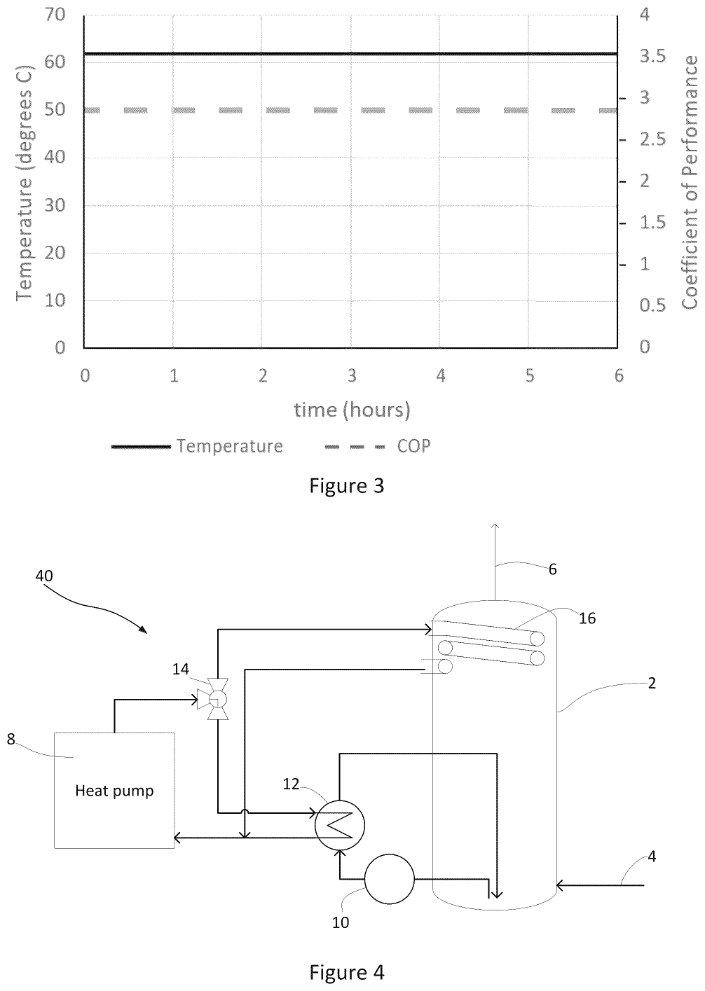

FIG. 3 is a graph of temperature and COP as a tank is heated according to a second example;

FIG. 4 is a schematic of a heating system according to one aspect;

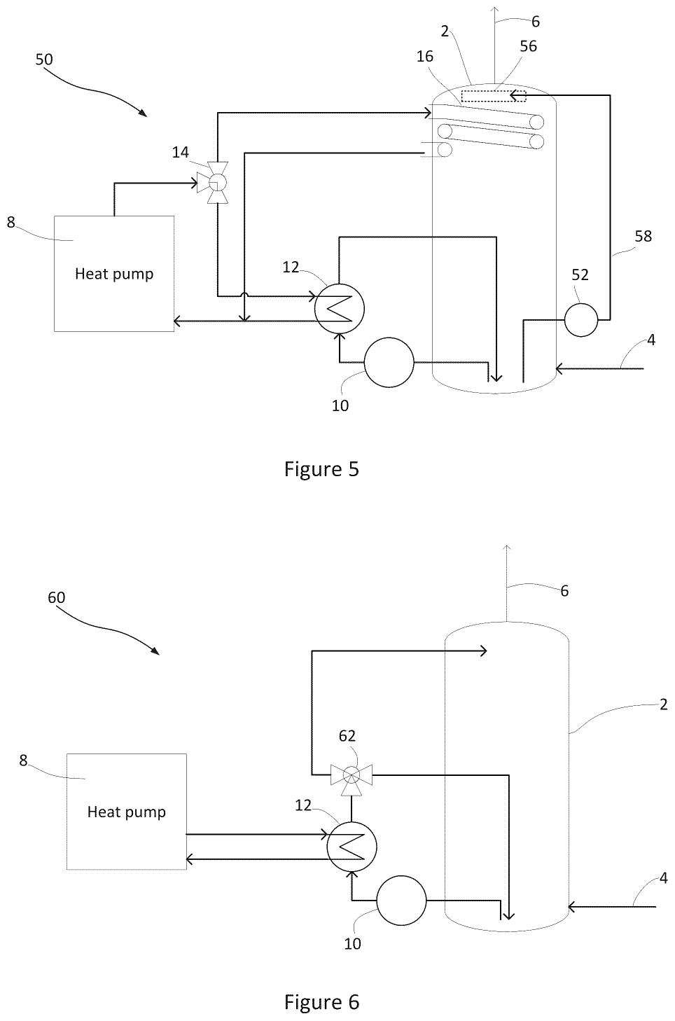

FIG. 5 is a schematic of a variant heating system with an additional fluid circuit;

FIG. 6 is a schematic of a heating system according to another aspect;

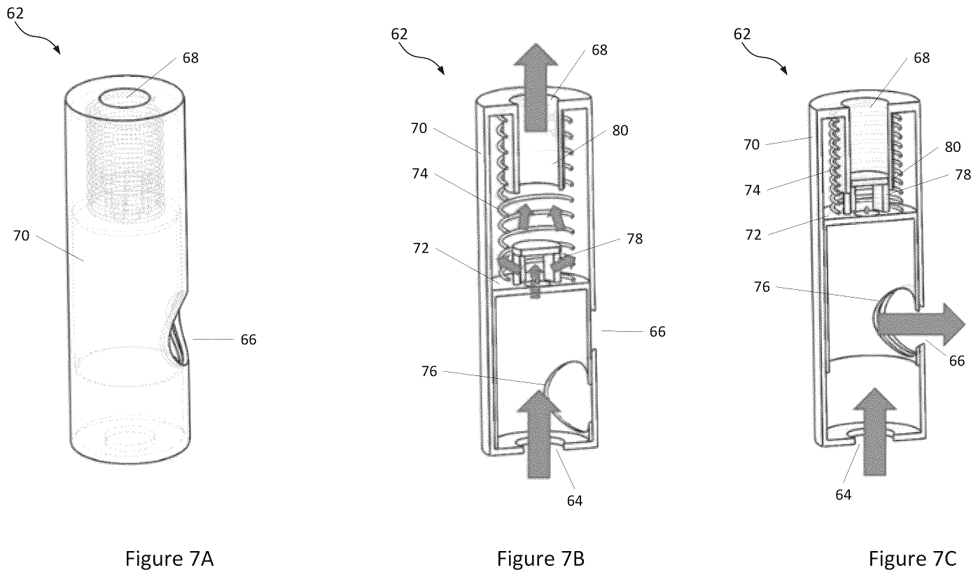

FIG. 7A is a perspective view of a three port valve;

FIG. 7B is a sectional view of the three port valve in a first configuration; and

FIG. 7C is a sectional view of the three port valve in a second configuration.

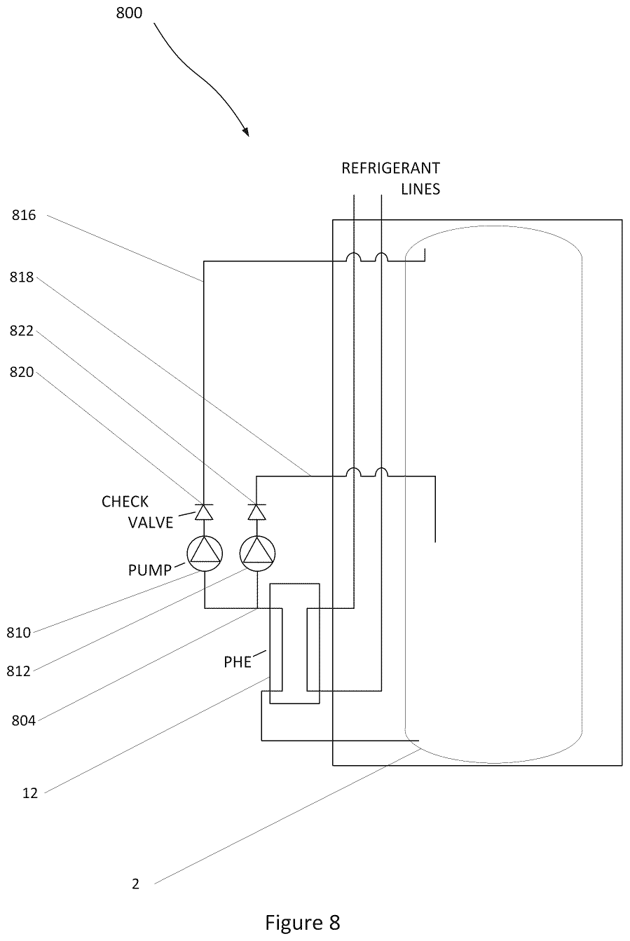

FIG. 8 is a schematic of a heating system according to a further aspect.

FIG. 1 shows a hot water tank arrangement 1 with a tank 2 having a cold water inlet 4 and a hot water outlet 6 for drawing off hot water. A pump 10 pumps water from the bottom of the tank to a heat exchanger 12 that receives heat from a heat pump 8. The heated water is returned to the tank 2.

The measure of water heating efficiency is known as the Coefficient of Performance or COP for short and is referred to herein as COP.

In an example, the heat source is at approximately 65° C., and the water in the tank is to be heated to a temperature suitable for use, e.g. 62° C. (typically above 50° C. to minimise the risk of exposure to Legionella or other pathogens, and below 70° C. to minimise the risk of scalding).

FIG. 2 shows a graph illustrating a first example for optimising the COP of the heating. In this example the flow rate of (cold) water into the heat exchanger is selected to enable the most efficient heat transfer. Generally, the higher the flow rate the better the COP is; this can be explained by the higher flow rate producing a turbulent boundary layer further into the heat exchanger, with the turbulent boundary layer providing more efficient heat transfer than the laminar boundary layer. Other factors affect flow speed too; for example for a large plate exchanger a lower flow speed can produce the same heat transfer as a smaller plate exchanger with a higher flow speed. The flow speed may be reduced or increased in dependence on performance of the heat source (be it e.g. seasonal variability or heat pump capability), but for maximum COP the flow speed is generally maintained as high as safely and conveniently available. The COP associated with heating water at 20° C. is around 3.5 whilst the COP associated with heating water at 60° C. is lower, for example 2.9. In this example water in the tank is permitted to heated up gradually, and the COP gradually drops as the tank is heated. In this example, the average COP is 3.2 for complete heating of the tank.

FIG. 3 shows a second example where the water is not permitted to heat up gradually, but instead the flow rate of cold water into the heat exchanger is selected to bring the water to the desired use temperature of 62° C. in a single pass through the heat exchanger. Here the COP associated with heating water is 2.9 throughout, and if this is used for complete heating of a tank's worth of water, then the COP remains 2.9 throughout.

It is observed that the first example provides optimum COP, but involves heating up the whole tank which may not be required, and can take several hours, e.g. 6 h in the example (and over 3 hours before the water is perceptibly warm); conversely the second example provides swift heating of smaller water quantities but at lower COP. Compared against the first example the second example incurs a 10% efficiency penalty.

Demands on hot water supply can be very variable and a user may only require a relatively small quantity of hot water for some tasks. When just a small quantity of water is needed, still requiring the entire contents of the tank to be heated is inefficient and can take quite long, both of which are undesirable.

It will be appreciated from the above that generally water heating systems may not optimise the COP for each particular use. The present invention aims to improve the COP and other factors in one or more types of usage situations.

It will also be appreciated that in heat pumps and many other heat sources the temperature of the heat source can vary, e.g. depending on type of heat pump, season, insolation, weather, etc. In order to ensure the hot water supply is maintained, the flow rate of cold water into the heat exchanger needs to be controlled accordingly. In order to bring water to a desired use temperature (e.g. 62° C.) in a single pass through the heat exchanger, real-time closed loop control of the pump can adapt the pump speed to match the heat output of the heat pump continuously. To achieve this a control strategy can factor in dynamic parameters of the system and the heat pump installation specifications.

FIG. 4 shows a heating system 40 that is adapted to provide water heating under optimisation of the COP for a number of different usage situations. As before, the tank 2 has a cold water inlet 4 for mains water and a hot water outlet 6 for drawing off hot water. A pump 10, preferably a variable speed pump, pumps water from the bottom of the tank to a first heat exchanger 12, preferably a plate heat exchanger, from where heated water is returned to the tank 2. The heat source (heat pump 8 in this example) provides heated fluid to a three port valve 14 (shown as an L-port ball valve, with other three port valves suitable as well) that is electronically controllable. The three port valve 14 can permit the heated fluid onward either into circuit to the ‘hot’ side of the heat exchanger 12, or to a second heat exchanger 16, preferably a heat transfer coil, that is arranged in an upper portion of the tank 2.

The 3 port electronic valve manages the heat transfer fluid from the heat pump to either the plate heat exchanger 12 or the heat transfer coil 16. The heat transfer coil 16 can deliver rapid reheat to a limited volume of water in the top of the tank, for immediate demand of hot water. The plate heat exchanger 12 can efficiently heat the tank gradually. A controller (not shown) can control the 3 port electronic valve 14 and select a flow path depending on hot water demand.

The system 40 can enable particularly robust control. Maximum heat can be at all times drawn from the heat pump, regardless of use scenario and dynamics of heat provided by the heat pump. Integration of the hot water system with the heat pump is straightforward.

For the three port valve 14 the more stringent requirements of material and parts in the hot water circuit (e.g. for potable water, as opposed to the heat transfer fluid) do not apply.

While not illustrated, a flow junction with non-return valves, or a further three port valve, can permit the return flows from the first and second heat exchangers back to the heat source.

In some examples the heat pump is adapted to provide a heat source at up to 90° C. (sometimes referred to as a ‘high temperature heat pump’). The heating system 40 may be particularly effective with a high temperature heat pump (or more generally with a heat source above 65° C.), as the heat transfer coil 16 can relatively quickly heat water in the top of the tank for immediate demand of hot water.

The heat transfer coil 16 may be arranged such that heated fluid from the heap pump enters at the top of the coil and flows back to the heat pump from the bottom of the coil. This can permit water at the top of the tank to become heated first, and then the heating of the water continuing downward toward the lower part of the coil. The height of the coil can be selected such that a suitable portion of the tank is heated for immediate use scenarios.

FIG. 5 shows a variant heating system 50 with an additional fluid circuit 58 where cold water is drawn from the bottom with a pump 52 and introduced in a diffuser 56 at the top of the tank, above the heat transfer coil 16. A non-return valve (not shown) can prevent cold water at the base of the tank from being drawn into the fluid circuit 58 when hot water is being drawn from the hot water outlet 6. The diffuser 56 serves to transfer heat energy from the heated water in the top of the tank to colder drawn water from bottom. By raising the temperature of the drawn water and reducing the temperature of the heated water the difference in temperature of the drawn water to the heated water in the tank is reduced. Were cold water to be introduced directly without the diffuser 56 the high temperature difference could cause the colder water to sink too rapidly, resulting in mixing to an extent that usefulness of the water in the upper part of the tank is reduced. This additional fluid circuit 58 can serve to increase the quantity of immediate-demand hot water, which would otherwise be limited to where the heat transfer coil 16 is located. The heated water has a lower density than colder water and forms a layer at the top of the tank. The cold water introduced by the additional fluid circuit 58 serves to push the thermocline downward beyond the bottom of the heat transfer coil 16.

FIG. 6 shows another heating system 60 that is adapted to provide water heating under optimisation of the COP for a number of different usage situations. As in the other examples, the tank 2 has a cold water inlet 4 for mains water and a hot water outlet 6 for drawing off hot water. A pump 10, preferably a variable speed pump, pumps water from the bottom of the tank to a heat exchanger 12, preferably a plate heat exchanger, where heat is received from the heat source (heat pump 8 in this example). Heated water is then provided to a three port valve 62 that is shown in more detail in FIG. 7. The three port valve 62 can permit the heated water onward either: to return to the bottom of the tank for efficiently heating the tank gradually; or to an upper portion of the tank for rapid delivery of a limited volume of hot water for immediate demand. Optionally a diffuser (not shown) is provided at the top of the tank to diffuse the heated water as it is introduced into the tank. Once a quantity of water is heated for immediate use at the top of the tank, the flow path for returning water to the bottom of the tank can permit the gradual heating to be resumed without disturbing the immediately available hot water at the top of the tank.

The variable speed pump 10 either pumps the water at a relatively slow rate, e.g. 1-2 l/min, to permit the water to receive sufficient heat to be immediately useful; or it pumps the water at a higher rate, e.g. 15-20 l/min, to permit the water to receive heat with high efficiency and high COP. A controller (not shown) can control the variable speed pump 10 and adjust the pump speed depending on hot water demand.

FIGS. 7A, 7B and 7C shows the three port valve 62 in more detail. FIG. 7A shows a perspective view of the three port valve 62, and 7B and 7C show a sectional views of the three port valve 62 in different configurations. The three port valve 62 includes three functional components: a housing 70, a shuttle 72 that is moveable in the housing 70 and an elastically deformable element, in the illustrated example a coil spring 74. The housing 70 includes an inlet port 64, a first outlet port 66 and a second outlet port 68. The shuttle 72 includes a first aperture 76 and a second aperture 78.

In the configuration shown in FIG. 7B the first aperture 76 is offset from the first outlet port 66 with no overlap, and the shuttle 72 closes the first outlet port 66. The second aperture 78 and the second outlet port 68 are open, and the three port valve 62 provides a flow path from the inlet port 64 to the second outlet port 68.

In the configuration shown in FIG. 7C the first aperture 76 of the shuttle 72 is aligned with the first outlet port 66. A portion of the shuttle 72 fits into the sleeve 80 and blocks flow to the second outlet port 68. The three port valve 62 provides a flow path from the inlet port 64 to the first outlet port 66.

The coil spring 74 urges the shuttle 72 in the housing 70 into the first configuration as shown in FIG. 7B, with a flow path from the inlet port 64 to the second outlet port 68. As the flow becomes stronger, the drag the flow exerts on the shuttle 72 as it flows through the second aperture 78 increases and the flow urges the shuttle 72 into the second configuration as shown in FIG. 7B, with a flow path from the inlet port 64 to the first outlet port 66.

The arrangement of the various apertures may vary from that shown in the example. For example the second aperture 78 is shown to include a number of openings in a cylindrical surface, and the sleeve 80 is cylindrically shaped to cover the openings. The openings may instead be arranged in the flat face of the shuttle with a corresponding portion of the housing arranged to cover the openings.

In an example the pipe diameter is 22 mm and the water flows at an average speed that can determined from the flow rate. The force the flow exercises on the shuttle can be understood as a combination of both drag and momentum associated with the flow stream changing direction. In an example, the drag coefficient at low flow rates, e.g. below 5 l/min, might be around 0.6 to 1; at higher flow rates, e.g. 15-20 l/min, the force on the shuttle can be around 0.3-1 N based on momentum. In an example the travel of the shuttle is about 30 mm. In the described example, the spring imposes a threshold force slightly below the lower end of the force range, e.g. 0.25 N. A suitable spring force can be achieved through a combination of different spring rates and free lengths. In an example a spring with a spring rate of 0.01 N/mm is used, and 25 mm of travel cause the spring to impose a force of 0.25 N. A further 30 mm of shuttle travel would bring the force to 0.55 N. Some additional free spring length is included to avoid the spring's ‘solid height’ and so a total free height of 70-80 mm in uncompressed length for a spring rate of 0.01 N/mm is provided in this example.

In an example, the features of the three port valve 62 are such that a flow path from the inlet port 64 to the second outlet port 68 is provided when the flow is water at a relatively slow rate, e.g. 1-2 l/min, and a flow path from the inlet port 64 to the first outlet port 66 is provided at a higher flow rate, e.g. 15-20 l/min.

The three port valve 62 can thus provide passive flow-dependent switching between the outlet ports, with a flow path provided to the first outlet port 66 at a higher flow rate and a flow path provided to the second outlet port 68 at a lower flow rate.

In an alternative, the three port valve may be actively controlled, for example, electronically by the controller. For instance, the three port valve may be controlled by the controller in dependence on a flow speed measurement e.g. at the three port valve 62; or in dependence on the variable speed pump, e.g. a speed or pump rate of the variable speed pump.

In the context of the heating system 60 the three port valve 62 with passive flow-dependent switching can provide particularly robust control of the flow, either to return to the bottom of the tank for efficiently heating the tank gradually; or to an upper portion of the tank for rapid delivery of a limited volume of hot water for immediate demand. Instead of a controller adjusting the pump speed and also switching the 3 port valve to select a flow path, both depending on hot water demand, the controller can just adjust the pump speed and the three port valve 62 consequently provides passive switching of the flow path depending on the flow speed.

FIG. 8 shows a heating system 800 that is adapted to provide water heating under optimisation of the COP for a number of different usage situations. As in the other examples, the tank 2 has a cold water inlet for mains water and a hot water outlet for drawing off hot water (not pictured). A heat source (for example a heat pump, not pictured) provides heated fluid via to the hot side of a plate heat exchanger 12 and returns the fluid to the heat pump via the refrigerant lines. The refrigerant lines may also, for example, deliver fluid to a spacing heating system.

The tank 2 may be surrounded by a wrapper. The wrapper may be an outer steel casing enclosing the tank 2, as schematically indicated in FIG. 8. Expanded foam insulation may be provided between the wrapper and the tank 2. The refrigerant lines may run between the wrapper and the tank 2 vessel so that they may be insulated without the need to provide further external insulation for the refrigerant lines.

The plate heat exchanger 12 receives water from the bottom of the tank 2 to be heated. The heated water is returned to either a lower region of the tank 2 for efficiently heating the tank gradually; or to an upper region of the tank 2 for rapid delivery of a limited volume of hot water for immediate demand. Two pumps 810, 812 (preferably variable speed pumps) are provided in order to pump water from the bottom of the tank 2 to the heat exchanger 12 and then to return it to the tank 2. Depending on which pump is used to pump the water, the heated water is returned via a different path to be returned to the tank 2 at a different height.

Upstream of the plate heat exchanger 12 a heated water return pipe divides into an upper return pipe 816 and a lower return pipe 818 at a three-way junction 804. The upper return pipe 816 returns heated water to an upper region of the tank 2 (for example at the top of the tank), the lower return pipe 818 returns heated water to a lower region of the tank 2 (for example towards the bottom of the tank).

In the upper return pipe 816 an upper return pump 810 is arranged to pump water from the bottom of the tank 2, through the plate heat exchanger 12 and through the upper return pipe 816 to return heated water the upper region of the tank 2. Upstream of the upper return pump 810 an optional check valve 820 is included to assist in preventing flow of water from the upper region of the tank back through the upper return pipe 816 towards the upper return pump 810.

In the lower return pipe 818 a lower return pump 812 is arranged to pump water from the bottom of the tank 2, through the plate heat exchanger 12 and through the lower return pipe 818 to return heated water the lower region of the tank. Upstream of the lower return pump an optional check valve 822 is included to assist in preventing flow of water from the lower region of the tank back through the lower return pipe 818 towards the lower return pump 812.

A controller (not shown) can control the variable speed upper and lower return pumps 810, 812 and adjust the pump speeds depending on hot water demand. In order to permit water to receive sufficient heat to be immediately useful the upper return pump 810 may pump the water at a relatively slow rate, e.g. 1-2 l/min to heat water sufficiently and return it to the upper region while the lower return pump 812 may be switched off such that no water is returned to the lower region. In order to permit water to receive heat with high efficiency and high COP the lower return pump 812 may pump water at a higher rate, e.g. 15-20 l/min, and return that water to the lower region while the upper pump 810 may be switched off to prevent the heated water being delivered to the upper region. By suitably controlling the upper and lower return pumps similar performance can be provided as in e.g. the system 60 including a single pump 10 and a three port valve 62 as described above. This can be particularly effective as suitable pumps are widely available and control of such pumps is straightforward. It will be appreciated that the heat exchangers described may take any one of a number of forms such as a simple plate heat exchanger or a heating water coil contained within a container arrangement.

Where the top of the tank is referred to herein (e.g. for drawing hot water from, for providing heated water to, or for locating a heat exchange coil), it should be appreciated that this may include near the top of the tank, an upper portion of the tank, a top portion of the tank, a top half, third or quarter of the tank (by volume or by height), with the tank in such orientation as it is intended to be installed for use. Where the bottom of the tank is described (e.g. for letting in cold water, for pumping water to be heated from), it should be appreciated that this may include near the bottom of the tank, in a lower portion of the tank, or in a bottom half, third or quarter of the tank (by volume or by height), with the tank in such orientation as it is intended to be installed for use.

Various other modifications will be apparent to those skilled in the art. For example, while the detailed description has considered a vessel such as a hot water tank, the disclosures herein could similarly be used with other fluids that are heated.

It will be understood that the present invention has been described above purely by way of example, and modifications of detail can be made within the scope of the invention.

Reference numerals appearing in the claims are by way of illustration only and shall have no limiting effect on the scope of the claims.

1. A system for heating water including:
a tank for holding water;
a heat pump to provide heat to water of the tank;
a heat exchanger arranged to transfer heat from the heat pump to water of the tank;
a variable speed pump for pumping water from the tank to the heat exchanger and back to the tank;
a three port valve arranged to provide a flow path from the heat exchanger either to the top of the tank or to the bottom of the tank depending on a flow rate; and
a controller adapted to control the variable speed pump depending on a hot water demand.

2. The system of claim 1, wherein the three port valve is a passive three port valve.

3. The system of claim 1 or claim 2, wherein the three port valve is arranged to provide a flow path from the heat exchanger to the top of the tank at a low flow rate, and to provide a flow path from the heat exchanger to the bottom of the tank at a high flow rate.

4. The system of claim 3, wherein the low flow rate is 5 l/min or less; and the high flow rate is 10 l/min or more.

5. The system of any of claims 1 to 4, wherein the controller is adapted to control the variable speed pump at a low flow rate in response to an immediate hot water demand or otherwise a high flow rate.

6. The system of any of claims 1 to 5, wherein the three port valve comprises a housing, a moveable shuttle, and an elastically deformable element arranged to urge the shuttle in the housing against flow into the three port valve.

7. The system of any of claims 1 to 6, further comprising a diffuser in the top of the tank arranged to receive heated water from the heat exchanger.

8. The system of any of claims 1 to 7, wherein the one of the flow paths from the heat exchanger is to a top ⅓ (by height) of the tank.

9. The system of any of claims 1 to 8, wherein the one of the flow paths from the heat exchanger is to a bottom ⅓ (by height) of the tank.

10. A method of heating water in a tank with a heat pump, the method including:
controlling a variable speed pump depending on a hot water demand;
pumping, by the variable speed pump, water in a hot water circuit from a tank to a heat exchanger for transferring heat from the heat pump to the water, and back to the tank;
and forming, by a three port valve, a flow path from the heat exchanger either to the top of the tank or to the bottom of the tank depending on a flow rate.

11. A kit of parts for a system for heating water in a tank with a heat pump, the kit of parts including:
a heat exchanger for attachment (i) to a heating fluid circuit from a heat pump to provide heat; and (ii) to a hot water circuit from a tank to receive heat;
a variable speed pump for pumping water in the hot water circuit from the tank to the heat exchanger and back to the tank;
a three port valve for forming a flow path from the heat exchanger either to the top of the tank or to the bottom of the tank depending on a flow rate; and
a controller adapted to control the variable speed pump depending on a hot water demand.

12. The kit of parts of claim 11, wherein the three port valve is a passive three port valve.

13. The kit of parts of claim 11 or claim 12, wherein the three port valve comprises a housing, a moveable shuttle, and an elastically deformable element arranged to urge the shuttle in the housing against flow into the three port valve.

14. The kit of parts of any of claims 11 to 13, wherein the three port valve is arranged to provide a flow path to a first outlet port when a flow rate is 10 l/min or more, and to provide a flow path to a second outlet port when a flow rate is 5 l/min or less.

15. The kit of parts of any of claims 11 to 14, wherein the controller is adapted to control the variable speed pump at a low flow rate in response to an immediate hot water demand or otherwise a high flow rate, preferably wherein the low flow rate is 5 l/min or less; and the high flow rate is 10 l/min or more.

16. A system for heating water including:
a tank for holding water;
a heat pump to provide heat to water of the tank;
a first heat exchanger arranged to transfer heat from the heat pump to water of the tank for gradual heating to a use temperature;
a second heat exchanger arranged to transfer heat from the heat pump to water of the tank for immediate heating to a use temperature;
a three port valve arranged to provide a flow path from the heat pump either toward the first heat exchanger or toward the second heat exchanger; and
a controller adapted to control the three port valve depending on a hot water demand.

17. The system of claim 16, wherein the first heat exchanger is outside the tank, with a pump arranged to pump water from the tank to the first heat exchanger and back to the tank.

18. The system of claim 17, wherein the pump is a variable speed pump adapted to pump the water at a high flow rate, preferably at least 5 l/min, more preferably at least 10 l/min, yet more preferably at least 15 l/min.

19. The system of claim 17 or 18, further comprising a conduit arranged to return water from the first heat exchanger to the bottom of the tank.

20. The system of any of claims 16 to 19, wherein the second heat exchanger is inside the tank.

21. The system of claim 20, wherein the second heat exchanger is at a top portion of the tank.

22. The system of any of claims 16 to 21, wherein the three port valve is electronically controllable.

23. The system of any of claims 16 to 22, further comprising a diffuser in the top of the tank and a pump arranged to pump water from the bottom of the tank to the diffuser.

24. A method of heating water in a tank with a heat pump, the method including:
forming, by way of a three port valve, a heating fluid circuit to connect the heat pump either to a first heat exchanger or to a second heat exchanger;
controlling the three port valve depending on a hot water demand;
where the first heat exchanger is arranged to transfer heat from the heat pump to water of the tank for gradual heating to a use temperature and the second heat exchanger is arranged to transfer heat from the heat pump to water of the tank for immediate heating to a use temperature;
and pumping, by way of a variable speed pump, water in a hot water circuit from the tank to the first heat exchanger and back to the tank.

25. A kit of parts for a system for heating water in a tank with a heat pump, the kit of parts including:
a first heat exchanger for attachment (i) to a heating fluid circuit from a heat pump to provide heat; and (ii) to a hot water circuit from a tank to receive heat;
a variable speed pump for pumping water in the hot water circuit from the tank to the first heat exchanger and back to the tank;
a conduit for attachment of a second heat exchanger in the tank to the heating fluid circuit to provide heat to the tank;
a three port valve for forming the heating fluid circuit to connect the heat pump either to the first heat exchanger or to the second heat exchanger; and
a controller adapted to control the three port valve depending on a hot water demand.

26. The kit of parts of claim 25, wherein the three port valve is electronically controllable.

27. A system for heating water including:
a tank for holding water;
a heat pump to provide heat to water of the tank;
a heat exchanger arranged to transfer heat from the heat pump to water of the tank;
a first pump arranged to pump water from the tank to the heat exchanger and back to an upper region of the tank;
a second pump arranged to pump water from the tank to the heat exchanger and back to a lower region of the tank; and
a controller adapted to control the first pump and the second pump depending on a hot water demand.

28. The system of claim 27, wherein a three-way junction is provided between the heat exchanger, the first pump and the second pump.

29. The system of claim 28, wherein the three-way junction is arranged to provide a first flow path to the first pump and onward to the upper region of the tank, and a second flow path to the second pump and onward to the lower region of the tank.

30. The system of claim 29, wherein the first flow path and/or the second flow path includes a check valve.

31. The system of any of claims 27 to 30, wherein the controller is adapted to switch on the first pump at a low flow rate or to switch on the second pump at a high flow rate.

32. The system of claim 31, wherein the low flow rate is 5 l/min or less.

33. The system of claim 31 or claim 32, wherein the high flow rate is 5 l/min or more, preferably 10 l/min or more; or more preferably 15 l/min or more.

34. The system of any of claims 27 to 33, wherein the controller is adapted to switch on the first pump in response to an immediate hot water demand.

35. The system of any of claims 27 to 34, wherein the controller is adapted to switch on the second pump in the absence of an immediate hot water demand.

36. The system of any of claims 27 to 35, further comprising a diffuser in the top of the tank arranged to receive heated water from the heat exchanger.

37. The system of any of claims 27 to 36, wherein the first pump is arranged to pump water to a top ⅓ (by height) of the tank.

38. The system of any of claims 27 to 37, wherein the second pump is arranged to pump water to a bottom ⅓ (by height) of the tank.
